(19) United States
(12) Patent Application Publication
(10) Pub. No.: US 2008/0187252 A1
(43) Pub. Date: Aug. 7, 2008

(54) Container for Packaging or Transport of Articles, and Method of Making Same

(75) Inventor: Antonio Dabrazzi, Brescia (IT)

Correspondence Address: SHOEMAKER AND MATTARE, LTD, 10 POST OFFICE ROAD - SUITE 110, SILVER SPRING, MD, 20910, US

(73) Assignee: D&C S.R.L., Brescia (IT)

(21) Appl. No.: 11/916,509

(22) PCT Filed: Jun. 14, 2006
(86) PCT No.: PCT/IT2006/000452

§ 371 Date: Dec. 4, 2007

(30) Foreign Application Priority Data
Jun. 14, 2005 (IT) BS2005A000072

(51) Int. Cl. B65D 33/06; B65D 30/00; B65D 33/00; B65D 30/08; B31B 1/14; B31B 1/00

(52) U.S. Cl. 383/12; 383/108; 383/105; 383/113; 493/227; 493/267

(57) ABSTRACT

The present invention relates to shopping bags, bags, cases, envelops and similar (15, 40) for the packaging or transport of articles, made of a composite material comprising at least a first layer (11), at least a second layer (12), and at least a third layer (13) arranged between said first and second layer. The intermediate layer can have an aesthetic and/or shock-absorbing purpose. The shopping bag further exhibits a flat bottom that improves its capacity.

The present invention in general relates to the field of packaging, in particular shopping bags, bags, cases, envelopes and similar for the packaging or transport of sundry articles.

In particular, the present invention relates to shopping bags, bags, cases, envelopes and similar made of a composite material, or consisting of multiple superimposed layers.

Normally, these envelopes are made of paper, cardboard or plastic material and have no special function but that of containing and transporting an article, also because they have to be inexpensive not to affect the cost of the article itself.

For example, if the article is fragile and therefore there is the need of protecting it, before it is placed in the bag or case it is wrapped into a shockproof material, such as “air film” or “Polibond”.

Moreover, such envelopes exhibit no special waterproof features and so, in the event of rain, it is necessary to pay special attention to prevent the article therein from becoming wet.

Similarly, such envelopes do not ensure that a liquid therein, for example escaped from a container, does not propagate outside as well.

Bags or envelopes have also been proposed which are made of multilayer materials, for example with two layers of plastic material, outside and inside, and an intermediate layer of paper or cardboard.

Such shopping bags are obtained by folding the starting composite material on itself and sewing the two side edges. The resulting product therefore has the shape of a bag.

In short, the bags thus manufactured substantially have an aesthetic purpose, but they do not offer a suitable capacity or particular functional advantages.

The object of the present invention is to propose shopping bags, bags and similar, capable of combining the possibility of countless aesthetic and custom solutions with a high capacity and further functional features.

Such object is achieved with a bag, a shopping bag or similar envelope in accordance with the following claim 1.

The features and advantages of the bag or similar envelope according to the present invention will appear more clearly from the following description of some preferred embodiments thereof, made by way of an indicative non-limiting example with reference to the annexed drawings, wherein:

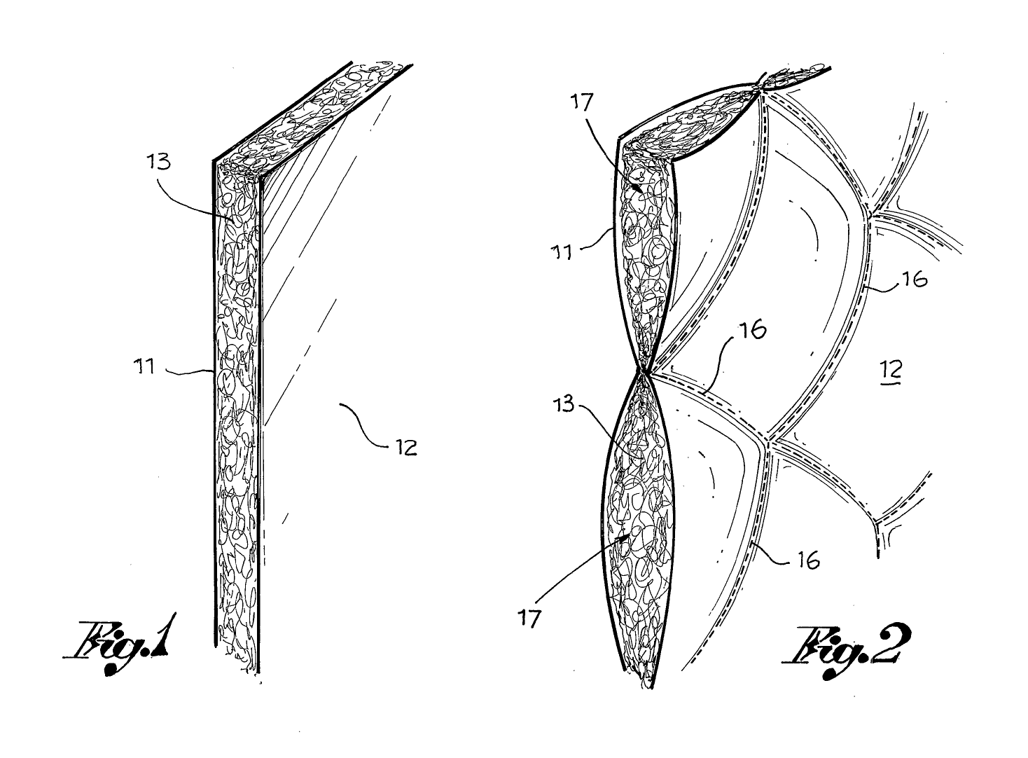

FIG. 1 shows an axial section view of a mattress of a composite material for manufacturing shopping bags, bags and similar, according to one embodiment;

FIG. 2 shows a cutaway view of the mattress of composite material in another embodiment;

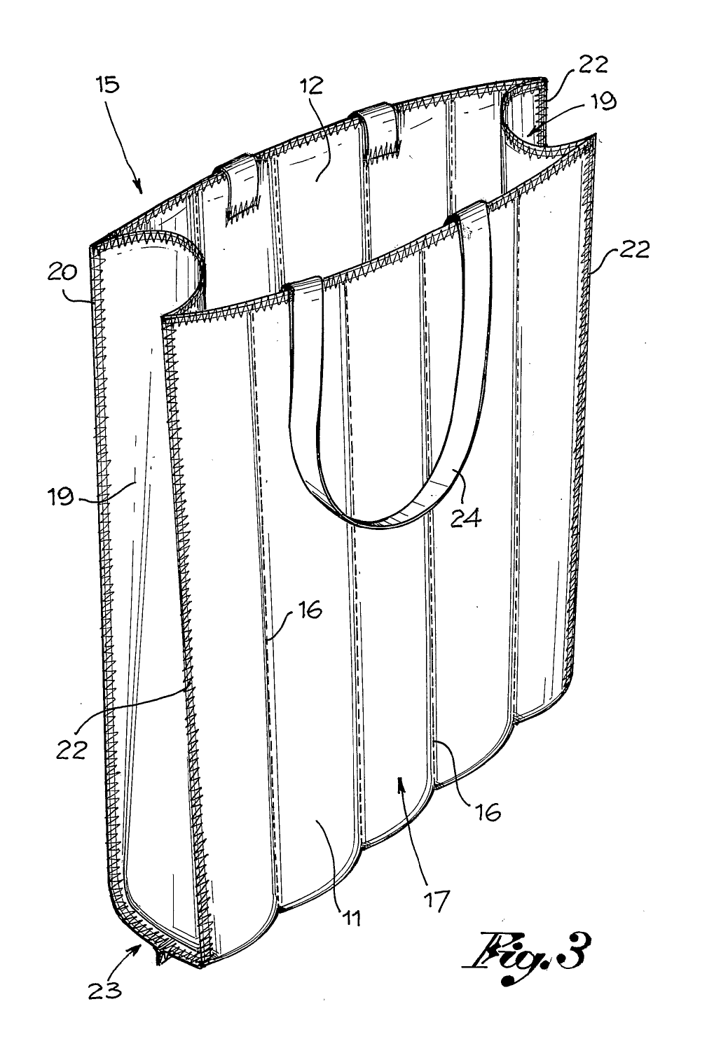

FIG. 3 shows a shopping bag according to the invention in one embodiment;

FIG. 4 shows the mattress of composite material, shaped so as to form a bag according to an embodiment variation;

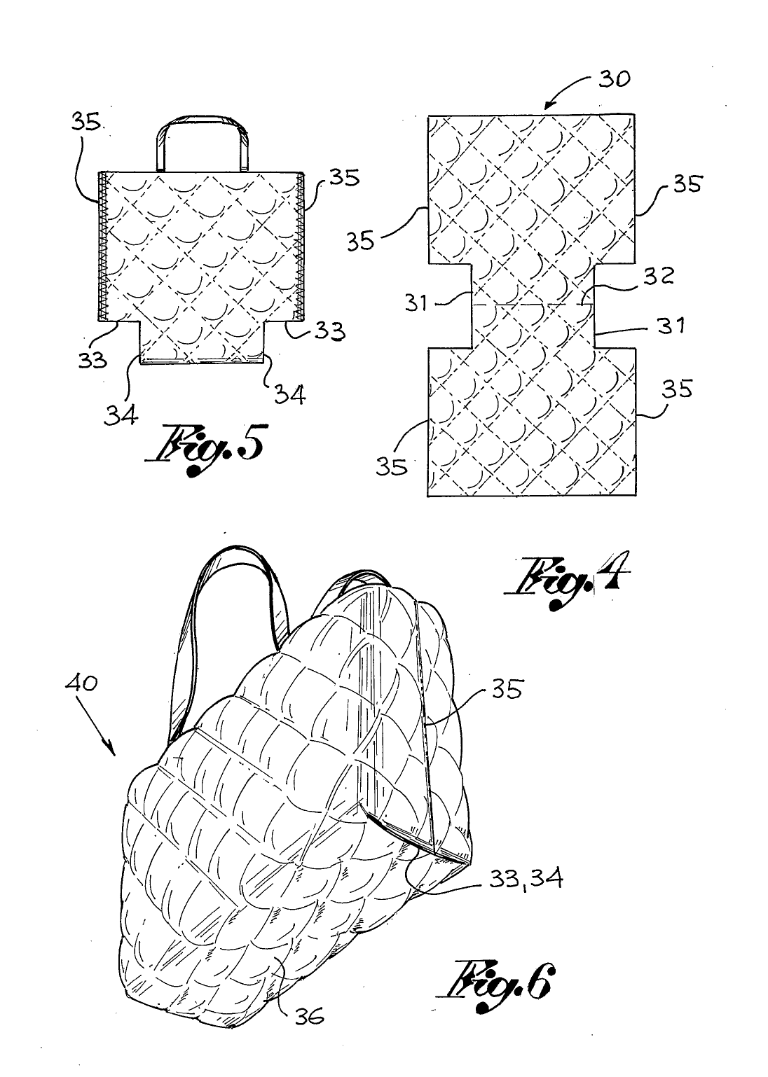

FIG. 5 shows a forming step of the bag; and

FIG. 6 shows the resulting bag.

FIGS. 1 and 2 show a portion of a mattress of a composite material comprising at least a first layer 11, at least a second layer 12, and at least a third layer 13 arranged between said first and second layer. In the following description, taking as a reference an envelope made of the composite material of the invention, for higher clarity of description, the first layer 11 will be defines as outer layer, the second layer 12 as inner layer, that is, facing inwards of said envelope, and the third layer 13 as intermediate layer.

In accordance with a preferred embodiment, at least one between the outer 11 and inner layer 12 is made of any material fully waterproof.

In accordance with a preferred embodiment, said layer is made with at least one sheet of a plastic material fully waterproof.

For example, such plastic material is selected from: polyethylene (PE), polypropylene (PPL), high-density polypropylene (HD), PVC, co-extruded polyethylene (PLTCOEX), metallized polypropylene, “air film” or “polibond”.

According to an advantageous embodiment, the intermediate material layer 13 is made of any material having shockproof properties, that is, shock-absorbing.

For example, said intermediate layer 13 is selected from: cotton wool, for example 100% polyester, foam rubber, non-woven fabric, cotton waste, terry towelling, latex, wool waste, capoque (that is, a material usually used for making inner padding), chenille.

In an other embodiment, the intermediate layer 13 consists of at least one sheet of paper or cardboard, for example carrying graphical representations on both sides which, if the material of the outer and/or inner layers is transparent, impart the desired aesthetic appearance to the article.

Advantageously, the outer 11 and inner layers 12 are made with the same material, so as to increase the waterproofing of envelope 14, 15, 40.

As an alternative, one of the two layers may be made of any material which allows at least protecting the intermediate layer 13 from wear. For example, a sheet of paper or cardboard, or a fabric, may be used as well.

The number of sheets used to make the layers of the composite material, the thickness of said sheets and the materials themselves are selected on the basis of the higher or lower consistency to impart to the envelope.

A thin composite material has the advantage of being easier to handle, malleable and folding.

A thicker composite material imparts higher solidity and stability to the envelope.

In a general embodiment, the three layers 11-13 of the composite material are simply sided and are connected to one another by the same seams of the edges that form envelope 15.

According to a preferred embodiment, the composite material is quilted, that is, it exhibits seams 16 that connect the outer layer 11 with the inner one 12 passing through the intermediate layer 13.

The quilt can be of any type and shape: more or less dense, with lines, geometrical patterns, for example lozenges or squares, etc. The seam that makes the quilt may even represent a logo or a brand, for example that of a shop that sells the article contained in the envelope.

The quilt, besides having the function of constraining the three layers to one another so that they do not move relative to one another, allows increasing the shock-absorbing effect since the intermediate layer 13, squashed at the seams, forms swollen zones 17 between said seams.

The shock-absorbing effect is substantially based on the type and density of the seams.

The quilt further imparts a pleasant aesthetic effect to envelope 14, 15, 40, which can be changed as desired according to the shape and type of seam and of the materials used.

Of course, it is possible to constrain the three layers of the material in many other ways, for example by gluing with glues, two-side adhesive tapes or sheets, buttons, etc.

In accordance with a general embodiment, the airbed of composite material described above is used to manufacture a shopping bag, bag, case, envelope and similar, which at each side thereof exhibits at least one side seam that extends by the entire height of the shopping bag or similar, and which ends at the bottom with a horizontal seam that defines a flat bottom for said shopping bag or similar.

In the embodiment shown in FIG. 3, the composite material of the present invention is used for making bags 15 of the bellow type.

In this case, the material and the thickness of the sheets used to make the composite material must be such as to impart the required stiffness to bag 15.

In accordance with a preferred embodiment of bag 15, the three layers 11-13 of the composite material are stretched out and superimposed, for example unwinding them from respective coils.

Advantageously, the quilting operation that constrains the three layers to one another is carried out continuously, that is, while the three layers are unwound from the respective coils and superimposed.

The composite material thus obtained is then cut to a desired shape and size (depending on the size and type of envelope to be obtained). In the case of the bag of FIG. 3, the composite material is cut into a rectangle.

Two opposite sides of the rectangle are then sided and sewn to one another (seam 20), thus obtaining a tubular element.

Parallel to seam 20, which forms a first side folding line, the tubular element is folded along three more predetermined folding lines, so as to obtain two opposite side bellow surfaces 19. Along each of said three folding lines of the composite material, a seam 22 is made so as to block the bellow structure of the tubular element.

One of the two openings of the tubular element is therefore closed and sewn so as to obtain bottom 23 of bag 15. A stiff element can then be inserted into said bottom.

Finally, gripping handles 24 of the bag can be applied to the other opening of the tubular element.

Advantageously, rather than using two different sheets for the inner and outer layers of the bag, it is possible to use a single sheet of double length as compared to that of the intermediate material, so that it can be folded on the latter.

The use of the same material for the outer and inner layers is advantageous also because it allows making envelope 14, 15, 40 with a single layer of waterproof material that is folded on the shockproof material 13. In this way, the edge delimiting the opening of envelope 14 or 15, 40 is closed by the flap of the waterproof material and the three separated layers are not noticed.

As an alternative, it is possible to close said edge by sewing the three layers to one another, as in the embodiment of FIG. 3, or folding and sewing it.

Moreover, rather than using a single sheet of composite material that is folded and sewn along two opposite sides thereof, two sheets sewn to one another along two corresponding opposite sides may be used. In this case, only two more folding lines and subsequent sewing will be required.

This allows making a bag with two different opposite surfaces, for example in colour, materials, quilting.

In FIG. 6, the airbed of composite material is used for obtaining a shopping bag 40 always having a flat bottom 35 but a single side surface 35 on each side.

The production method of a shopping bag, bag or similar 40 provides the cutting of the airbed of composite material in the shape of a rectangle 30 with two facing recesses 31, obtained along two opposite sides 35.

Each recess 31 is delimited by cross edges 33, which define the depth of the rectangular shape, and by a longitudinal edge 34, which defines the extension thereof (FIG. 4).

Rectangle 30 is then folded on itself along a median folding line 32 that connects the longitudinal edges 34 of the two recesses 31. Sides 35 of the rectangle are sewn to one another, whereas the sides parallel to the folding line 32 are left separate for defining the opening of bag 40 (FIG. 5).

After that, the cross edges 33 are sided and sewn to the longitudinal edges 34, so that the portion of rectangle of composite material comprised between said longitudinal edges defines a flat bottom 36 for the bag.

To avoid leaving the seams visible, the bag may be upturned relative to the opening thereof.

Gripping handles may be applied to the bag thus obtained.

In this way, a bag 40 is obtained which has no side bellow surfaces (there is just one seam 35 on each side), but which exhibits a flat bottom 36 suitable for receiving a stiff element.

Advantagteously, rather than using two different sheets for the inner and outer layers of the bag, it is possible to use a single sheet of double length as compared to that of the intermediate material, so that it can be folded on the latter.

The use of the same material for the outer and inner layers is advantageous also because it allows making bag 40 with a single layer of waterproof material that is folded on the intermediate layer 13. In this way, the edge delimiting the opening of envelope 40 is closed by the flap of the waterproof material and the three separated layers are not noticed.

As an alternative, it is possible to close said edge by sewing the three layers to one another, or folding and sewing it.

It is clear that a man skilled in the art may make several changes and variations to the shopping bag, bag or similar and to the production method thereof in order to meet specific and incidental needs, all falling within the scope of protection of the invention as defined in the following claims.

1-38. (canceled)

39. A container such as a shopping bag, bag, case, envelope or the like, made of a composite material, said container comprising at least one first layer, at least one second layer, and at least one third layer arranged between said first and second layer, said container having, at each side thereof, at least one side seam that extends the entire height of the container, and which ends at the bottom with a horizontal seam that defines a flat bottom for said container.

40. A container according to claim 39, comprising, in each side thereof, two side seams defining a side bellow surface.

41. A container according to claim 39, wherein said flat bottom is a stiff element.

42. A container according to claim 39, further comprising a pair of gripping handles.

43. A container according to claim 39, wherein at least one of said first and second layer comprises a fully waterproof material.

44. A container according to claim 43, wherein said first and/or said second layer comprises at least one sheet of a plastic material which is fully waterproof.

45. A container according to claim 44, wherein said plastic material is selected from the group consisting of polyethylene (PE), polypropylene (PPL), high-density polypropylene (HD), PVC, co-extruded polyethylene (PLTCOEX), metallized polypropylene, and mixtures thereof.

46. A container according to claim 39, wherein said third layer is made of any material having shock-absorbing properties.

47. A container according to claim 46, wherein said third layer comprises at least one layer of a material selected from the group consisting of cotton wool, 100% polyester, foam rubber, non-woven fabric, cotton waste, terry towelling, latex, wool waste, capoque, chenille and mixtures thereof.

48. A container according to claim 39, wherein said third layer is made of a sheet of paper or cardboard.

49. A container according to claim 39, wherein the first and the second layer are made of the same material.

50. A container according to claim 39, wherein one of the first and the second layer is made with a material suitable for protecting the third layer from wear by contact with the contents of the container.

51. A container according to claim 39, wherein one of the first and the second layer comprises at least one sheet of paper or cardboard or fabric.

52. A container according to claim 39, wherein the layers of the composite material are connected to one another only at the seams of the container.

53. A container according to claim 39, wherein said composite material is quilted, having a plurality of seams that connect the first and the second layer passing through the third layer.

54. A container according to claim 39, wherein the first layer and the second layer of the composite material are formed by a single layer folded on the third layer.

55. A method of making a container of a composite material according to claim 39 and having a flat bottom suitable for receiving a stiff element and side bellow surfaces, comprising steps of:
making a tubular element starting from a sheet of substantially rectangular shape of said composite material sewn along two opposite sides thereof or from two sheets sewn along two corresponding opposite sides;
folding the tubular element along folding lines parallel to the sewn sides, so as to obtain two opposite side bellow surfaces;
making a seam along each of said folding lines;
closing one of the two openings of the tubular element;
applying a pair of handles at the other opening of the tubular element.

56. A method of making a container according to claim 39, comprising steps of:
cutting the composite material in the shape of a rectangle with two facing recesses, obtained along two opposite sides, each recess being delimited by parallel cross edges, which define the depth thereof, and by a longitudinal edge, which defines the extension thereof;
folding said rectangle on itself along a median folding line that connects the longitudinal edges of the two recesses;
sewing the sides of the rectangle carrying the recesses to one another, leaving the remaining opposite sides of the rectangle separate;
siding and sewing the cross edges to the longitudinal edge of each recess, so that the portion of rectangle of composite material comprised between the longitudinal edges of the recesses defines a flat bottom for the container.

57. A method according to claim 56, wherein the container obtained is upturned relative to the opening thereof.
